(19) United States
(12) Patent Application Publication
(10) Pub. No.: US 2025/0205701 A1
(43) Pub. Date: Jun. 26, 2025

(54) MICROFLUIDIC ASSEMBLY AND METHOD FOR OPERATING A MICROFLUIDIC ASSEMBLY

(71) Applicant: INTERFACE FLUIDICS LTD., CALGARY (CA)

(72) Inventors: DAVID O'BRIEN, EDMONTON (CA); THOMAS DE HAAS, EDMONTON (CA)

(73) Assignee: INTERFACE FLUIDICS LTD., CALGARY, AB (CA)

(21) Appl. No.: 18/848,190

(22) PCT Filed: Apr. 3, 2023
(86) PCT No.: PCT/CA2023/050448

§ 371 Date: Sep. 18, 2024

Related U.S. Application Data
(60) Provisional application No. 63/329,966, filed on Apr. 12, 2022.

(51) Int. Cl. B01L 3/00; B01L 9/00

(52) U.S. Cl. CPC B01L 3/502715; B01L 3/502738; B01L 9/527; B01L 2200/027; B01L 2200/0689; B01L 2300/047; B01L 2300/0887; B01L 2400/0487

(57) ABSTRACT

A microfluidic assembly includes a microfluidic chip having first and second inlet/outlet ports, and a fluid pathway between the first and second inlet/outlet ports. A manifold supports the microfluidic chip. A fluid delivery assembly is coupled to the microfluidic chip by the manifold for delivering fluid to/from the microfluidic chip. The fluid delivery assembly includes a fluid lumen and a seal, and is movable between a closed configuration in which the seal is advanced to prevent fluid communication between the fluid lumen and the first inlet/outlet port, and an open configuration in which the seal is retracted to allow fluid communication between the fluid lumen and the first inlet/outlet port. A pump forces fluid flow between the fluid lumen and the first inlet/outlet port when the fluid delivery assembly is in the open configuration.

### CROSS-REFERENCES TO RELATED APPLICATIONS

This application claims priority to U.S. Provisional Patent Application No. 63/329,966 filed on Apr. 12, 2022.

### FIELD

This document relates to microfluidics. More specifically, this document relates to manifolds and fluid delivery assemblies usable in microfluidics, and related methods.

### BACKGROUND

U.S. Patent Application Publication No. 20210339258 A1 (De Haas et al.) discloses a microfluidic chip and holder assembly that includes a base having a seat and at least a first fluid channel that extends through the base. The first fluid channel has an inlet that is spaced from the seat for connection to a fluid supply and an outlet that is in the seat. A microfluidic chip is received by the seat, and the microfluidic chip has a fluid pathway. A cover is mounted over the microfluidic chip to sandwich the microfluidic chip between the cover and the base. The cover bears against the microfluidic chip to force the microfluidic chip to bear against the base and form a sealed connection between the outlet of the fluid channel and the fluid pathway of the microfluidic chip.

### SUMMARY

The following summary is intended to introduce the reader to various aspects of the detailed description, but not to define or delimit any invention.

Microfluidic assemblies are disclosed. According to some aspects, a microfluidic assembly includes a microfluidic chip having at least a first inlet/outlet port and a second inlet/outlet port, and fluid pathway providing fluid communication between the first inlet/outlet port and the second inlet/outlet port. A manifold supports the microfluidic chip. At least a first fluid delivery assembly is coupled to the microfluidic chip by the manifold, for delivering fluid to and/or from the first inlet/outlet port. The first fluid delivery assembly includes a fluid lumen and a seal. The first fluid delivery assembly is movable between a closed configuration in which the seal is advanced to prevent fluid communication between the fluid lumen and the first inlet/outlet port, and an open configuration in which the seal is retracted to allow fluid communication between the fluid lumen and the first inlet/outlet port. A pump forces fluid flow between the fluid lumen and the first inlet/outlet port when the first fluid delivery assembly is in the open configuration.

In some examples, in the closed configuration, the seal is forced against the first inlet/outlet port to seal the first inlet/outlet port.

In some examples, in the open configuration, the seal is spaced from the first inlet/outlet port.

In some examples, the manifold includes a receptacle that provides access to the first inlet/outlet port, and the first fluid delivery assembly includes a fluid line that provides the fluid lumen. An end of the fluid line can be received in the receptacle for delivering fluid to and/or from the first inlet/outlet port through the manifold.

In some examples, the seal is mounted to the fluid line. In the closed configuration, the fluid line can be forced towards the microfluidic chip to force the seal against the first inlet/outlet port. In the open configuration, the fluid line can be moved away from the microfluidic chip to space the seal from the first inlet/outlet port.

In some examples, the receptacle includes a chamber adjacent the first inlet/outlet port. The end of the fluid line can be received in the chamber both when the fluid delivery assembly is in the closed configuration and when the fluid delivery assembly is in the open configuration. In the open configuration, fluid can be delivered between the first inlet/outlet port and the fluid line via the chamber.

In some examples, the seal is mounted to the end of the fluid line and extends around an opening of the lumen. For example, the seal can be or can include an o-ring.

In some examples, the fluid lumen and the first inlet/outlet port are eccentric.

In some examples, the first fluid delivery assembly is biased towards the closed configuration. The first fluid delivery assembly can further include an actuator for moving the first fluid delivery assembly towards the open configuration. The actuator can be a piezoelectric actuator, and upon activation of the piezoelectric actuator, the piezoelectric actuator can expand to move the fluid delivery line away from the microfluidic chip.

In some examples, the first fluid delivery assembly further includes a housing that is mounted to the receptacle and in which the piezoelectric actuator is received. The first fluid line can extend through the housing and through the piezoelectric actuator.

In some examples, the first fluid delivery assembly further includes a spring housed within the housing for biasing the first fluid delivery assembly towards the closed configuration.

In some examples, the manifold includes a base and a cover, and the microfluidic chip is sandwiched between the base and the cover with the base and the cover bearing against the microfluidic chip, for example to apply a confining pressure to the microfluidic chip.

Microfluidic manifold and fluid delivery assemblies are further disclosed. According to some aspects, a microfluidic manifold and fluid delivery assembly includes a manifold for supporting a microfluidic chip. At least a first fluid delivery assembly is provided for delivering fluid to and from the microfluidic chip through the manifold. The first fluid delivery assembly includes a fluid lumen and a seal, and the first fluid delivery assembly is movable between a closed configuration in which the seal is advanced through the manifold to prevent flow of fluid through fluid lumen, and an open configuration in which the seal is retracted to allow fluid flow through the fluid lumen.

In some examples, in the closed configuration, the seal is forced against a hole to seal the hole.

In some examples, the manifold includes a receptacle, and the first fluid delivery assembly includes a fluid line that provides the fluid lumen. An end of the fluid line can be received in the first receptacle for delivering fluid through the manifold.

In some examples, the seal is mounted to the fluid line. In the closed configuration, the fluid line can be advanced through the receptacle to advance the seal, and in the open configuration, the fluid line can be retracted through the receptacle to retract the seal

In some examples, the receptacle includes a chamber. The end of the fluid line can be received in the chamber both when the fluid delivery assembly is in the closed configuration and when the fluid delivery assembly is in the open configuration. In the open configuration, fluid can be delivered to and/or from the fluid line via the chamber.

In some examples, the seal is mounted to the end of the fluid line and extends around an opening of the fluid lumen. For example, the seal can be or can include an o-ring.

In some examples, the first fluid delivery assembly is biased towards the closed configuration. The fluid delivery assembly can further include an actuator for moving the first fluid delivery assembly towards the open configuration. The actuator can be a piezoelectric actuator, and upon activation of the piezoelectric actuator, the piezoelectric actuator can expand to retract the fluid line.

In some examples, the first fluid delivery assembly further includes a housing that is mountable to the receptacle and in which the piezoelectric actuator is received. The fluid line can extend through the housing and through the piezoelectric actuator.

In some examples, the first fluid delivery assembly further includes a spring housed within the housing for biasing the first fluid delivery assembly towards the closed configuration.

In some examples, the manifold includes a base and a cover, and the microfluidic chip is receivable between the base and the cover with the base and the cover bearing against the microfluidic chip, for example to apply a confining pressure to the microfluidic chip.

Methods for operating microfluidic assemblies are also disclosed. According to some aspects, a method for operating a microfluidic assembly includes: a) with a microfluidic chip assembled to a first fluid delivery assembly via a manifold, advancing a seal of the first fluid delivery assembly through the manifold, to prevent fluid communication between the first fluid delivery assembly and a first inlet/outlet port of the microfluidic chip.

In some examples, advancing the seal includes forcing the seal against the first inlet/outlet port of the microfluidic chip, to seal the first fluid inlet/outlet port.

In some examples, step a) includes using a spring to force the seal against the first inlet/outlet port.

In some examples, the method further includes: b) retracting the seal to allow fluid communication between the first fluid delivery assembly and the first inlet/outlet port; and c) delivering a fluid from the first fluid delivery assembly into the first inlet/outlet port.

Step b) can include applying a voltage to a piezoelectric actuator to retract the seal.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a perspective view of an example microfluidic assembly, including a microfluidic chip, a manifold (wherein the cover of the manifold is shown removed from the base), a set of fluid delivery assemblies, and a set of pumps;

FIG. 2A is a perspective view of the microfluidic chip of FIG. 1;

FIG. 2B is a top plan view of the microfluidic chip of FIG. 1;

FIG. 3A is a cross-section taken through the microfluidic chip, base, and first fluid delivery assembly of FIG. 1, showing the fluid delivery assembly removed from the base;

FIG. 3B is an enlarged view of the encircled portion of FIG. 3A;

FIG. 4A is a cross-section taken through the microfluidic chip, base, and first fluid delivery assembly of FIG. 1, showing the first fluid delivery assembly assembled to the base and in the closed configuration;

FIG. 4B is an enlarged view of the encircled portion of FIG. 4A;

FIG. 4C is a partial perspective view of the fluid line of the first fluid delivery assembly;

FIG. 5A is a cross-section taken through the microfluidic chip, base, and first fluid delivery assembly of FIG. 1, showing the first fluid delivery assembly assembled to the base and in the open configuration; and

FIG. 5B is an enlarged view of the encircled portion of FIG. 4A;

### DETAILED DESCRIPTION

Various apparatuses or processes or compositions will be described below to provide an example of an embodiment of the claimed subject matter. No embodiment described below limits any claim and any claim may cover processes or apparatuses or compositions that differ from those described below. The claims are not limited to apparatuses or processes or compositions having all of the features of any one apparatus or process or composition described below or to features common to multiple or all of the apparatuses or processes or compositions described below. It is possible that an apparatus or process or composition described below is not an embodiment of any exclusive right granted by issuance of this patent application. Any subject matter described below and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth in order to provide a thorough understanding of the subject matter described herein. However, it will be understood by those of ordinary skill in the art that the subject matter described herein may be practiced without these specific details. In other instances, well-known methods, procedures and components have not been described in detail so as not to obscure the subject matter described herein. The description is not to be considered as limiting the scope of the subject matter described herein.

The terms “coupled” or “coupling” or “connected” or “connecting” as used herein can have several different meanings depending on the context in which these terms are used. For example, these terms can have a mechanical, fluid, electrical or communicative connotation. For further example, these terms can indicate that two or more elements or devices are directly connected to one another or connected to one another through one or more intermediate elements or devices via an electrical element, electrical signal, or a mechanical element depending on the particular context. For further example, these terms can indicate that two or more elements or devices are connected to one another such that fluid may flow between the elements or devices.

As used herein, the wording “and/or” is intended to represent an inclusive-or. That is, “X and/or Y” is intended to mean X or Y or both. As a further example, “X, Y, and/or Z” is intended to mean X or Y or Z or any combination thereof. Furthermore, the phrase “at least one of X, Y, and Z” is intended to mean X or Y or Z or any combination thereof.

Terms of degree such as “substantially”, “about”, and “approximately” as used herein mean a reasonable amount of deviation of the modified term such that the end result is not significantly changed. These terms of degree may also be construed as including a deviation of the modified term if this deviation would not negate the meaning of the term it modifies.

Any recitation of numerical ranges by endpoints herein includes all numbers and fractions subsumed within that range, including the endpoints (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

Generally disclosed herein are fluid delivery assemblies for delivering fluids to and/or from a microfluidic chip, and related assemblies and methods of use. The fluid delivery assemblies can generally allow for fluid to be delivered to and/or from a microfluidic chip in a controlled fashion (by allowing for the inlet/outlet ports of the microfluidic chip to be selectively sealed or un-sealed), and with minimal or low dead volume.

In some examples, a fluid delivery assembly can direct fluid into and/or out of a microfluidic chip via a manifold, which can generally serve to hold the microfluidic chip and to couple the fluid delivery assembly to the microfluidic chip, while allowing for optical access to the microfluidic chip (e.g. for the purpose of assessing the flow of fluids through the microfluidic chip). In general, when the fluid delivery assembly and the microfluidic chip are coupled together via the manifold, the fluid delivery assembly can be movable between a closed configuration in which a seal thereof (e.g. an o-ring) is advanced and optionally forced against the microfluidic chip to prevent fluid communication between the fluid delivery assembly and the microfluidic chip, and an open configuration in which the seal is retracted and optionally spaced from the microfluidic chip to allow fluid communication between the fluid delivery assembly and the microfluidic chip. In examples in which the seal is forced directly against the microfluidic chip in the closed configuration, dead volume is minimized or reduced.

The fluid delivery assemblies can in some examples be used under high pressure conditions. That is, the fluid delivery assemblies can direct fluid into and/or out of a microfluidic chip under high pressure (e.g. with fluids pressurized to greater than 300 bar, for example up to 1000 bar). The fluid delivery assemblies can be used in various types of microfluidic processes and to hold various types of microfluidic chips, but may be particularly useful in microfluidic research involving the modelling of subterranean formations (e.g. oil-bearing shale formations), which can require that high pressure conditions be created in a microfluidic chip.

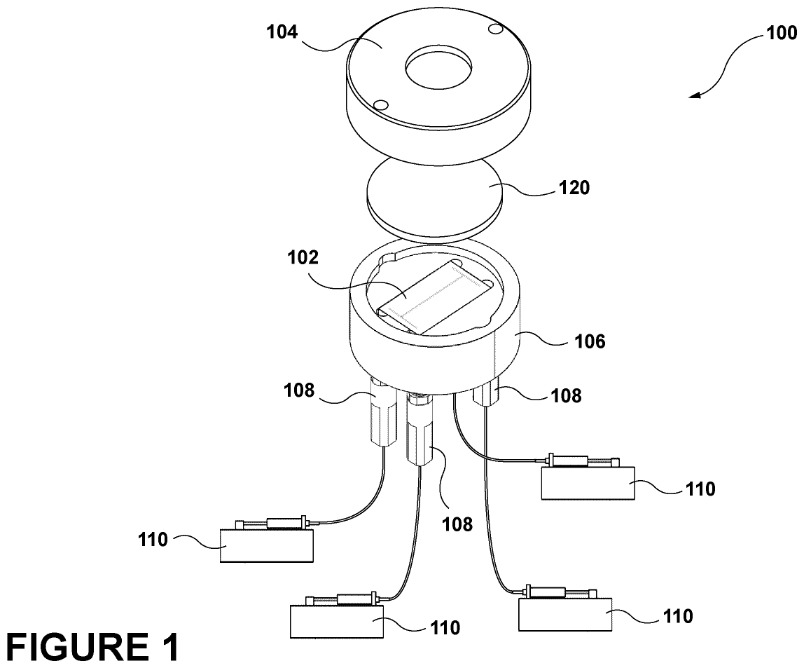

Referring now to FIG. 1, a microfluidic assembly 100 is shown. The microfluidic assembly 100 generally includes a microfluidic chip 102; a manifold, which includes a cover 104 and a base 106, and which supports the microfluidic chip 102; four fluid delivery assemblies 108 (only three of which are visible in FIG. 1) coupled to the microfluidic chip 102 via the manifold (i.e. via the base 106 of the manifold), for delivering fluid to and/or from microfluidic chip 102 via the manifold; and a set of pumps 110 for forcing fluid flow between the fluid delivery assemblies 108 and the microfluidic chip 102.

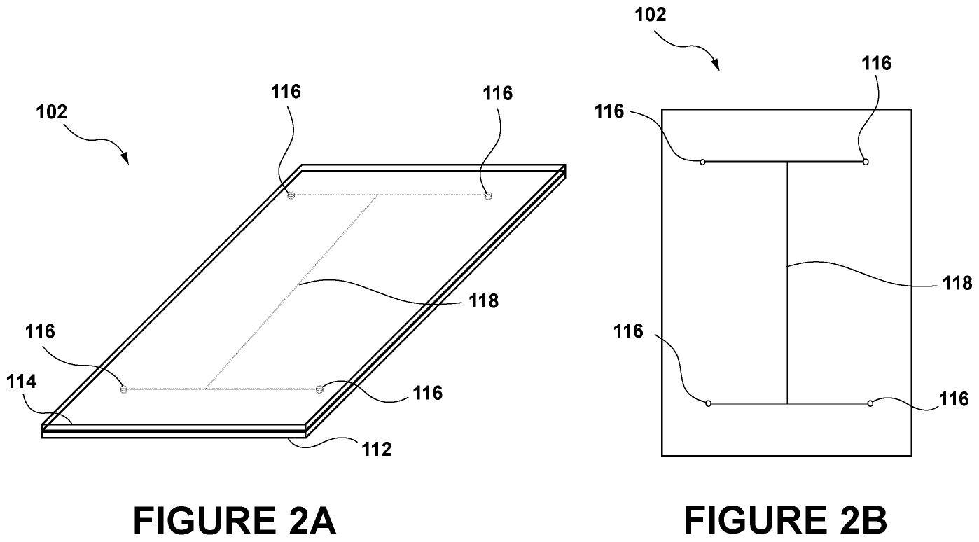

Various microfluidic chips may be used in the assemblies described herein. Referring to FIGS. 2A and 2B, in the example shown, the microfluidic chip 102 includes a base panel 112 in which various microfluidic features (i.e. inlet/outlet ports and a fluid pathway, described in further detail below) are formed (e.g. by etching or drilling), and a cover panel 114 that is secured to the base panel (e.g. by anodic bonding) and that covers the microfluidic features. In the example shown, the base panel 112 is an opaque silicon wafer, and the cover panel 114 is a transparent glass panel that is anodically bonded to the silicon wafer. The microfluidic chip 102 allows for optical investigation (e.g. imaging, optionally with the use of an optical microscope and/or video recording equipment and/or a photographic camera) of at least some of the microfluidic features.

In alternative examples, the microfluidic chip may be of another configuration. For example, both the base panel and the cover panel can be a transparent glass panel, or the base panel can be a transparent glass panel while the cover panel can be an opaque silicon wafer.

Referring still to FIGS. 2A and 2B, in the example shown, the microfluidic chip 102 includes a set of inlet/outlet ports 116 (i.e. first through fourth inlet/outlet ports 116). A fluid pathway 118 provides fluid communication between the inlet/outlet ports 116. Fluid can enter the microfluidic chip 102 via any one of the inlet/outlet ports 116, and can then flow through the fluid pathway 118 to any other of the inlet/outlet ports 116, where it can then exit the microfluidic chip 102.

In alternative examples, the microfluidic features can be of another configuration. For example, a microfluidic chip can include another number of inlet/outlet ports (i.e. at least two inlet/outlet ports, so that one may serve as an inlet, and one may serve as an outlet), and various configurations of fluid pathways. Various examples of microfluidic chips usable in the assemblies described herein are disclosed in United States Patent Application Publication No. US 2020/0215541 A1 (Abedini et al.); United States Patent Application Publication No. US 2020/0309285 A1 (Sinton et al.); U.S. Pat. No. 10,001,435 (Sinton et al.); International Patent Application Publication No. WO/2021/253112 (Ahitan et al.); International Patent Application Publication No. WO/2022/126252 (Ahitan et al.); and U.S. Provisional Patent Application No. 63/391,819 (Soni et al.). Each of the aforementioned documents is hereby incorporated herein by reference in its entirety.

The fluid delivery assemblies disclosed herein can be used with a manifold of any suitable design that supports a microfluidic chip and that couples the fluid delivery assemblies to the microfluidic chip. Referring back to FIG. 1, in the example shown, the manifold includes cover 104 and base 106, which are forced together with the microfluidic chip 102 therebetween, to apply a confining pressure to the microfluidic chip 102. For example, the manifold can include a cover and a base that are screwed together with a microfluidic chip therebetween, as is described in US patent application publication nos. 2021/0162421 (de Haas et al.) and 2021/0339258 (de Haas et al.), which are incorporated herein by reference in their entirety. Alternatively, the manifold can include a cover and a base that are forced together with the use of hydraulics, with a microfluidic chip therebetween, as is described in International Patent Application Publication No. PCT/CA2022/050860 (de Haas et al.), which is incorporated herein by reference in its entirety. Alternatively, the manifold can be of another design, such as that disclosed in U.S. Provisional Patent Application No. 63/413,698 (de Haas et al.), which is incorporated herein by reference in its entirety. In the example shown, the microfluidic chip 102 is seated on the base 106, and fluids are routed to and from the microfluidic chip 102 through the base 106 (as will be described in further detail below). The cover 104 includes a viewing window in which a transparent panel 120 is seated, and a microscope lens (not shown) can be positioned above the cover 104 (and optionally mounted to the cover 104 or another part of the manifold) to view the microfluidic chip 102 through the transparent panel 120. The cover 104 and the base 106 can be manufactured from, for example, stainless steel or titanium or a corrosion resistant alloy, and the transparent panel 120 can be, for example, a sapphire panel.

The pumps used in the assemblies disclosed herein can be of any suitable design that can force fluid through a microfluidic chip, via the fluid delivery assemblies 108 and the manifold, either with positive or negative pressure. That is, as used herein, the term “pump” refers to any apparatus that provides a sufficient pressure differential to force fluid through a microfluidic chip, via the fluid delivery assemblies 108 and the manifold. For example, the pump can be a tank with or without a regulator. Referring still to FIG. 1, in the example shown, the pumps 110 are syringe pumps.

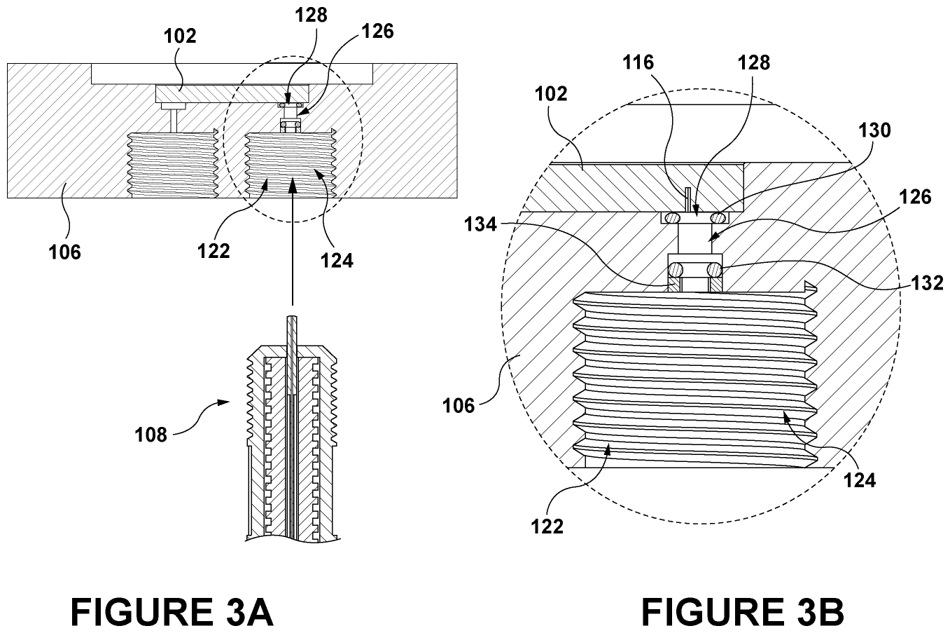

Referring now to FIGS. 3A to 5B, the fluid delivery assemblies 108 will be described in greater detail. Particularly, the first fluid delivery assembly 108 will be described in detail. In the example shown, the second through fourth fluid delivery assemblies 108 are identical to the first fluid delivery assembly 108, and thus for brevity are not described in detail. Furthermore, in FIGS. 3A to 5B, only the base 106 of the manifold, the microfluidic chip 102, and the first fluid delivery assembly 108 are shown assembled together. For clarity, the cover 104 of the manifold is omitted, as are the second through fourth fluid delivery assemblies 108.

Referring first to FIG. 3A, as mentioned above, the first fluid delivery assembly 108 is coupled to the microfluidic chip 102 by the manifold. Particularly, in the example shown, the base 106 includes a receptacle 122, which provides access to the first inlet/outlet port 116 (visible in FIG. 3B) of the microfluidic chip 102. As shown in FIG. 3B, the receptacle 122 generally includes three sections: a threaded cavity 124, a channel 126, and a chamber 128. The first fluid delivery assembly 108 is inserted into the receptacle 122 and screwed into the threaded cavity 124, to assemble the first fluid delivery assembly 108 to the manifold. The chamber 128 is adjacent and open to the first inlet/outlet port 116 of the microfluidic chip 102, and is sealed to the microfluidic chip 102 by an o-ring 130. The channel 126 extends between the threaded cavity 124 and the chamber 128, to provide access to the chamber 128 from the threaded cavity 124. The manifold further includes an additional o-ring 132, as well as a back up ring 134, for sealing the manifold to the first fluid delivery assembly 108.

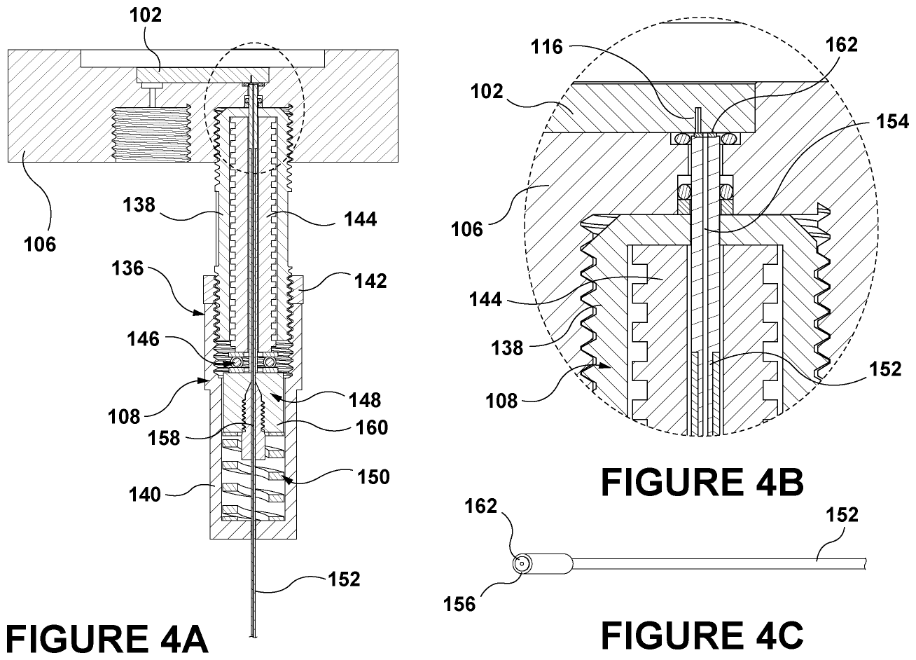

Referring next to FIGS. 4A and 4B, in the example shown, the first fluid delivery assembly 108 includes housing 136. The housing 136 includes an upper section 138, which is screwed into the threaded cavity 124 (labelled in FIGS. 3A and 3B), a lower section 140, which is screwed to the upper section 138, and a lock nut 142.

Referring still to FIGS. 4A and 4B, the first fluid delivery assembly 108 further includes an actuator 144, which is received in the upper section 138. As will be described in greater detail below, the actuator 144 causes movement of the first fluid delivery assembly 108 from the closed configuration towards the open configuration. In the example shown, the actuator 144 is a piezoelectric actuator; however, in other examples, other types of actuators are possible. For example, the actuator could be or could include a solenoid, a shape memory alloy, or an expanding material (e.g. Teflon with a heater). For simplicity, the electrical wiring to the actuator 144 is not shown.

Referring still to FIGS. 4A and 4B, in the example shown, the actuator 144 has a first end that bears against the upper section 138 of the housing, and a second end that bears against a bearing assembly 146, to protect the actuator 144 from rotational forces. The bearing assembly 146 in turn bears against a block and fitting assembly 148 (described in further detail below). The block and fitting assembly 148 in turn bears against a biasing member 150. In the example shown, the biasing member 150 is a spring; however, in other examples, other types of biasing members are possible. The biasing member 150 in turn bears against the lower section 140 of the housing.

Referring also to FIG. 4C, the first fluid delivery assembly 108 further includes a fluid line 152, which defines a fluid lumen 154 (visible in FIG. 4B). The fluid line 152 extends from the first pump 112 (shown in FIG. 1) and into the lower section 140 of the housing 136. The fluid line 152 then extends through the biasing member 150, through the block and fitting assembly 148, through the bearing assembly 146, through the actuator 144, and out of the upper section 138 of the housing 136. The fluid line 152 then extends through the fluid channel 126 of the receptacle 122 (labelled in FIG. 3B), and the end 156 of the fluid line 152 is received in the chamber 128 (labelled in FIG. 3B). The fluid lumen 154 is open at the end 156 of the fluid line 152. The fluid line 152 can be, for example, stainless steel or Hastelloy tubing.

Referring still to FIG. 4A, the block and fitting assembly 148 includes a fitting 158 and a block 160. The fitting 158 is fixedly secured to the fluid line 152 (e.g. by compression fitting), and is screwed into the block 160. Accordingly, longitudinal movement of the block and fitting assembly 148 through the housing 136 (e.g. due to force applied by the biasing member 150 or due to activation of the actuator 144, as will be described below) causes longitudinal movement of the fluid line 152.

As can be seen in FIG. 4B, the fluid lumen 154 and the first inlet/outlet port 116 of the microfluidic chip 102 are eccentric. Furthermore, as shown in FIG. 4C, the fluid delivery assembly includes a seal 162, which in the example shown is mounted to the end 156 of the fluid line 152 and extends around the opening of the fluid lumen 154. The seal 162 can be, for example, a sheet of rubber, a fluorocarbon-based fluoroelastomer o-ring, or another elastomeric seal. In alternative examples, the seal can be of another configuration. For example, the seal may not extend entirely around the opening of the fluid lumen 154.

As mentioned above, the first fluid delivery assembly 108 is movable between a closed configuration in which fluid communication between the first fluid delivery assembly 108 and the first inlet/outlet port 116 is prevented, and an open configuration in which fluid communication between the first fluid delivery assembly 108 and the first inlet/outlet port 116 is allowed. Referring back to FIGS. 4A and 4B, the first fluid delivery assembly 108 is shown in the closed configuration. In this configuration, the actuator 144 is in a neutral state (e.g. with zero voltage or a relatively low voltage applied to the actuator 144), and thus the biasing member 150 forces the block and fitting assembly 148 towards the microfluidic chip 102, which in turn forces the fluid line 152 towards the microfluidic chip 102. The seal 162 is thus forced against the first inlet/outlet port 116 to seal the first inlet/outlet port 116, which prevents fluid communication between the fluid lumen 154 and the first inlet/outlet port 116. As such, any fluid forced through the microfluidic chip 102 (e.g. via the other inlet/outlet ports 116) generally cannot exit the microfluidic chip 102 via the first inlet/outlet port 116, and fluid forced from the pump 112 through the fluid line 152 generally cannot enter the microfluidic chip 102 via the first fluid inlet/outlet port 116.

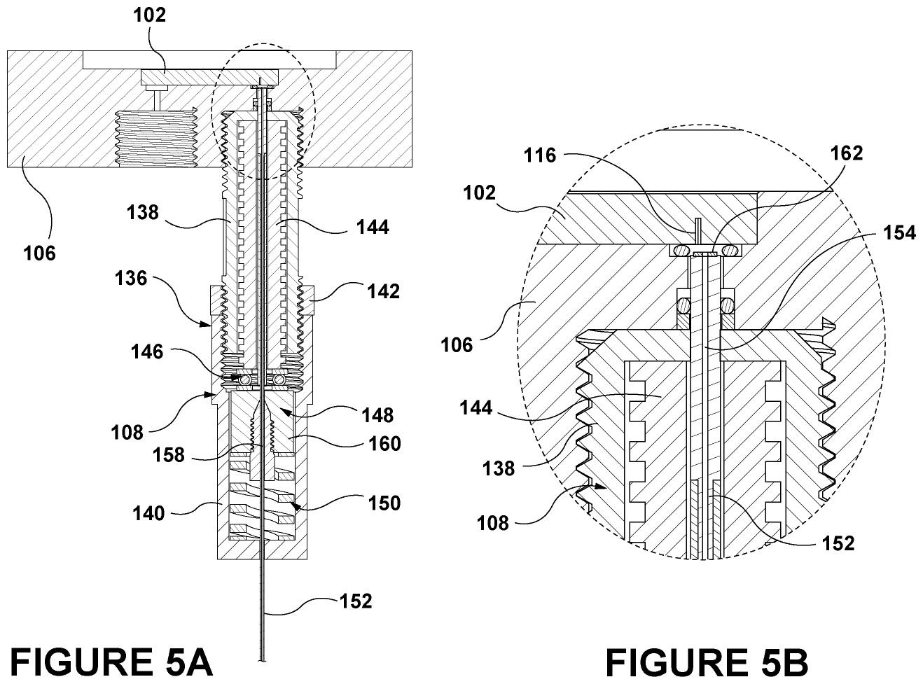

Referring now to FIGS. 5A and 5B, the first fluid delivery assembly 108 is shown in the open configuration. To move from the closed configuration to the open configuration, the actuator 144 is activated (i.e. by applying a DC voltage thereto, or by increasing the DC voltage applied thereto) and expands longitudinally, to retract the fluid line 152 through the receptacle 122 (labelled in FIG. 3B) and away from the microfluidic chip 102. Particularly, due to the confinement of the actuator 144 in the upper section 138 of the housing 136, on expansion of the actuator 144, the actuator 144 forces the bearing assembly 146 away from the microfluidic chip 102, which in turn forces the block and fitting assembly 148 away from the microfluidic chip 102, which in turn compresses the biasing member 150. The movement of the block and fitting assembly 148 away from the microfluidic chip 102 causes movement of the fluid line 152 away from the microfluidic chip 102, to retract the seal 162 and space the seal 162 from the first inlet/outlet port 116 of the microfluidic chip 102. When the seal 162 is spaced from the first inlet/outlet port 116 of the microfluidic chip 102, the fluid lumen 154 is in fluid communication with the first inlet/outlet 116 port via the chamber 128 (labelled in FIG. 3B). Fluid can thus be delivered between the first inlet/outlet port 116 and the fluid line 152 via the chamber 128. For example, fluid forced through the microfluidic chip 102 can exit the microfluidic chip 102 via the first inlet/outlet port 116, and fluid forced from the pump 112 through the fluid line 152 can enter the microfluidic chip 102 via the first fluid inlet/outlet port 116.

In order to move from the open configuration back to the closed configuration, activation of the actuator 144 may be ceased, thus allowing the biasing member 150 to expand, to advance the fluid line 152 back towards the microfluidic chip 102, and thus advance the seal 162 through the receptacle 122 such that the seal is again forced against the first inlet/outlet port 116.

In going between the closed configuration and the open configuration, the fluid line 152 may move by a relatively small amount, for example by between about 30 microns and 250 microns (e.g. by about 50 microns). Thus, whether in the closed configuration or the open configuration, the end 156 of the fluid line 152 remains in the chamber 128.

In the example shown, because the first fluid delivery assembly 108 seals directly to the microfluidic chip 102, dead volume within the assembly 100 is minimized or reduced. However, in other examples, the fluid delivery assembly may seal to another element, such an element of the manifold. That is, the seal 162 may be advanced through the manifold to seal to a hole of the microfluidic chip such as the fluid inlet/outlet port, or to a hole within the manifold.

In the example shown, the first fluid delivery assembly 108 is biased towards the closed configuration. In alternative examples, the first fluid delivery assembly 108 can be biased towards the open configuration. For example, the biasing member 150 can be received in the upper section 138 of the housing 136, and the actuator 144 can be received in the lower section 140 of the housing 136.

While the above description provides examples of one or more processes or apparatuses or compositions, it will be appreciated that other processes or apparatuses or compositions may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be re-visited.

1. A microfluidic assembly comprising:
a microfluidic chip having at least a first inlet/outlet port and a second inlet/outlet port, and fluid pathway providing fluid communication between the first inlet/outlet port and the second inlet/outlet port;
a manifold supporting the microfluidic chip;
at least a first fluid delivery assembly coupled to the microfluidic chip by the manifold for delivering fluid to and/or from the first inlet/outlet port, wherein the first fluid delivery assembly comprises a fluid lumen and a seal, and wherein the first fluid delivery assembly is movable between a closed configuration in which the seal is advanced to prevent fluid communication between the fluid lumen and the first inlet/outlet port, and an open configuration in which the seal is retracted to allow fluid communication between the fluid lumen and the first inlet/outlet port; and
a pump for forcing fluid flow between the fluid lumen and the first inlet/outlet port when the first fluid delivery assembly is in the open configuration.

2. The microfluidic assembly of claim 1, wherein in the closed configuration, the seal is forced against the first inlet/outlet port to seal the first inlet/outlet port, and in the open configuration, the seal is spaced from the first inlet/outlet port.

3. (canceled)

4. The microfluidic assembly of claim 2, wherein:
the manifold comprises a receptacle that provides access to the first inlet/outlet port; and
the first fluid delivery assembly comprises a fluid line that provides the fluid lumen, wherein an end of the fluid line is received in the receptacle for delivering fluid to and/or from the first inlet/outlet port through the manifold.

5. The microfluidic assembly of claim 4, wherein:
the seal is mounted to the fluid line;
in the closed configuration, the fluid line is forced towards the microfluidic chip to force the seal against the first inlet/outlet port; and
in the open configuration, the fluid line is moved away from the microfluidic chip to space the seal from the first inlet/outlet port.

6. The microfluidic assembly of claim 4, wherein:
the receptacle comprises a chamber adjacent the first inlet/outlet port;
the end of the fluid line is received in the chamber when the first fluid delivery assembly is in the closed configuration and when the first fluid delivery assembly is in the open configuration;
in the open configuration, fluid is delivered between the first inlet/outlet port and the fluid line via the chamber; and
the seal is mounted to the end of the fluid line and extends around an opening of the lumen.

7. (canceled)

8. (canceled)

9. The microfluidic assembly of claim 1, wherein the fluid lumen and the first inlet/outlet port are eccentric.

10. The microfluidic assembly of claim 1, wherein the first fluid delivery assembly is biased towards the closed configuration, and the first fluid delivery assembly further comprises an actuator for moving the first fluid delivery assembly towards the open configuration.

11. (canceled)

12. The microfluidic assembly claim 10, wherein the actuator is a piezoelectric actuator, and whereby upon activation of the piezoelectric actuator, the piezoelectric actuator expands to move the first fluid delivery line away from the microfluidic chip.

13. (canceled)

14. (canceled)

15. The microfluidic assembly of claim 1, wherein the manifold comprises a base and a cover, wherein the microfluidic chip is sandwiched between the base and the cover with the base and the cover bearing against the microfluidic chip.

16. A microfluidic manifold and fluid delivery assembly comprising:
a manifold for supporting a microfluidic chip;
at least a first fluid delivery assembly for delivering fluid to and from the microfluidic chip through the manifold, wherein the first fluid delivery assembly comprises a fluid lumen and a seal, and wherein the first fluid delivery assembly is movable between a closed configuration in which the seal is advanced through the manifold to prevent flow of fluid through the fluid lumen, and an open configuration in which the seal is retracted to allow fluid flow through the fluid lumen.

17. The microfluidic manifold and fluid delivery assembly of claim 16, wherein in the closed configuration, the seal is forced against a hole to seal the hole.

18. The microfluidic manifold and fluid delivery assembly of claim 16, wherein:
the manifold comprises a receptacle;
the first fluid delivery assembly comprises a fluid line that provides the fluid lumen, wherein an end of the fluid line is received in the first receptacle for delivering fluid through the manifold;
the seal is mounted to the fluid line;
in the closed configuration, the first fluid line is advanced through the receptacle to advance the seal; and
in the open configuration, the fluid line retracted through the receptacle to retract the seal.

19. (canceled)

20. The microfluidic manifold and fluid delivery assembly of claim 18, wherein:
the receptacle comprises a chamber;
the end of the fluid line is received in the chamber when the first fluid delivery assembly is in the closed configuration and when the first fluid delivery assembly is in the open configuration; and
in the open configuration, fluid is delivered to and/or from the fluid line via the chamber.

21. (canceled)

22. (canceled)

23. The microfluidic manifold and fluid delivery assembly of claim 16, wherein the first fluid delivery assembly is biased towards the closed configuration, and the first fluid delivery assembly further comprises an actuator for moving the first fluid delivery assembly towards the open configuration.

24. (canceled)

25. The microfluidic manifold and fluid delivery assembly of claim 23, wherein the actuator is a piezoelectric actuator, and whereby upon activation of the piezoelectric actuator, the piezoelectric actuator expands to retract the fluid line.

26. (canceled)

27. (canceled)

28. (canceled)

29. A method for operating a microfluidic assembly, comprising:
a. with a microfluidic chip assembled to a first fluid delivery assembly via a manifold, advancing a seal of the first fluid delivery assembly through the manifold, to prevent fluid communication between the first fluid delivery assembly and a first inlet/outlet port of the microfluidic chip.

30. The method of claim 29, wherein advancing the seal comprises forcing the seal against the first inlet/outlet port of the microfluidic chip, to seal the first fluid inlet/outlet port.

31. The method of claim 29, wherein step a. comprises using a spring to advance the seal.

32. The method of claim 31, further comprising:
b. retracting the seal to allow fluid communication between the first fluid delivery assembly and the first inlet/outlet port; and
c. delivering a fluid from the first fluid delivery assembly into the first inlet/outlet port.

33. The method of claim 32, wherein step b. comprises applying a voltage to a piezoelectric actuator to retract the seal.
